(19) United States
(12) Patent Application Publication
(10) Pub. No.: US 2006/0092995 A1
(43) Pub. Date: May 4, 2006

(54) High-power mode-locked laser system

(75) Inventors: Robert D. Frankel, Rochester, NY (US); John Hoose, Fairport, NY (US)

Correspondence Address: FISH & NEAVE IP GROUP;ROPES & GRAY LLP, ONE INTERNATIONAL PLACE, BOSTON, MA, 02110-2624, US

(73) Assignee: Chromaplex, Inc., West Henriette, NY (US)

(21) Appl. No.: 11/036,600

(22) Filed: Jan. 14, 2005

Related U.S. Application Data
(63) Continuation-in-part of application No. 10/997,224, filed on Nov. 23, 2004.
Application No. 10/997,224 is a continuation-in-part of application No. 10/978,808, filed on Nov. 1, 2004.

(51) Int. Cl. H01S 3/098; H01S 3/10; H01S 3/08

(52) U.S. Cl. 372/18; 372/20; 372/102

(57) ABSTRACT

A multi-wavelength, commonly mode-locked external cavity laser system includes a solid state gain element generating a collinearly propagating multi-wavelength optical beam, a diffracting element that diffracts the multi-wavelength optical beam into a plurality of diffracted optical beams, a wavelength-selective device receiving the plurality of diffracted optical beams and controllably transmitting or reflecting the diffracted optical beams depending on their wavelengths, and at least one mode-locking device that mode-locks the optical beams from the gain elements in common and thus forms a mode-locked optical output beam of picosecond or femtosecond duration and high peak power.

### CROSS-REFERENCE TO OTHER PATENT APPLICATIONS

This application is a continuation-in-part of U.S. patent application Ser. No. 10/997,224, filed Nov. 23, 2004, which is a continuation-in-part of U.S. patent application Ser. No. 10/978,808, filed Nov. 1, 2004, the contents of which are incorporated herein by reference in their entirety.

### BACKGROUND OF THE INVENTION

The invention relates to a laser system, and more particularly to an external cavity laser system with an intra-cavity dispersive device and plurality of tunable phase and switching elements placed in the frequency dispersed beam producing a combined output beam of picosecond or femtosecond pulses with high peak power and composed of selectable optical wavelengths.

Lasers with pulse widths less than 1 picosecond (ps) and more particularly less than 100 femtoseconds (fs) are finding increasingly applications in science and industry. Applications include non-linear spectroscopy, multi-photon microscopy, 2-photon lithography, writing sub-wavelength structures on optical storage media and ultra-fast machining. Often it is desirable to synchronize and phase-lock more than one sub-picosecond laser pulse to probe the electronic or vibrational structure of matter, such as the Raman vibronic signature of organic and biological molecules by non-linear Coherent Anti-Stokes Raman Spectroscopy (CARS). CARS signals are formed by a four-wave mixing process that requires 2-3 separate stimulating laser wavelengths, or possibly in excess of 6 time- and phase-coherent laser pulses in separate frequency bands if probing several transitions simultaneously. Raman transitions in the liquid state are spectrally broadened to 10 cm⁻¹ which requires a bandwidth of about 0.05 to 0.3 nm. Raman transitions in the solid state may be half as wide or less. Raman vibrational transitions may be 300-3400 cm⁻¹ in energy and require a laser medium with a bandwidth of 300 nm (from 680-980 nm), such as Ti: Sapphire, to cover the entire Raman region, simultaneously probing in excess of 100 distinct Raman transitions.

Two or more short laser pulses (duration of less than 1 ps) composed of separate spectral bands can be time- or phase-locked in different ways. For example, several separate femtosecond lasers may be time-locked, either electronically or by sharing common cavity elements, such as a semiconductor saturable absorber mirror (SESAM) mode locker or common gain element, in a master-slave configuration. In another approach, an independently tunable dual-wavelength Ti:Sapphire laser has been demonstrated where two cavities share a Ti:Sapphire laser crystal in a common Z-fold section. Two separate output beams were produced.

It would therefore be desirable to have a picosecond or femtosecond laser system that provides high pulse energies as well as selectable frequencies of emission of mode-locked pulses that may encompass non-adjacent optical frequency emission regions and is easily self starting for spectroscopic applications.

### SUMMARY OF THE INVENTION

The described external cavity mode-locked laser system is directed, inter alia, to generating multi-wavelength short (picosecond or femtosecond) phase-locked pulses with high peak power, and more particularly to a laser system with intra-cavity transmissive or reflective elements for selecting the spectral content of the mode-locked pulses.

According to one aspect of the invention, a mode-locked external cavity laser system includes a gain element collinearly propagating a multi-wavelength optical beam, a diffracting element that diffracts the multi-wavelength optical beam exiting a first face of the gain element into a plurality of diffracted optical beams, a wavelength-selective device receiving the plurality of diffracted optical beams and controllably transmitting diffracted optical beams with a selected wavelength, and at least one mode-locking device configured to commonly mode-lock the multi-wavelength optical beam.

With this approach, the average power per/wavelength band is increased by providing optical gain only in selected wavelength bands in the gain medium.

Advantageous embodiments of the invention may include one or more of the following features. The gain element can include a solid state laser material, for example, a Ti:Sapphire crystal, a Cr:LiSAF crystal, and/or an Er-doped or Yb-doped glass. Other lasing materials, both in crystalline and amorphous form, that exhibit a suitably broad gain curve may be employed. The mode-locking device may include at least one semiconductor saturable absorber mirror (SESAM). The wavelength-selective device may include an addressable liquid-crystal light valve, which can have spaced-apart separately controllable pixels capable of changing amplitude or phase of the transmitted optical beams. Alternatively or in addition, the wavelength-selective device may include an array of actuatable micro-machined mirrors (MEMS), and/or may be a fixed patterned phase and amplitude plate. The system may also include means, such as a prism pair, to compensate for dispersion in the collinear output beam.

In addition, the system can include a phase-measuring device that intercepts a portion of the collinear optical beam exiting a second face of the gain medium and determines a phase characteristic of the exiting collinear multi-wavelength optical beam, as well as a phase adjuster configured to separately adjust an optical path length of the plurality of diffracted optical beams in response to the determined phase characteristic.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 shows schematically a commonly mode-locked multi-wavelength external cavity solid state laser with an intra-cavity wavelength-selective device;

FIG. 2 shows schematically details of the wavelength-selective device of FIG. 1; and

FIG. 3 shows the solid state laser of FIG. 1 with an active phase control system.

### DETAILED DESCRIPTION OF CERTAIN ILLUSTRATED EMBODIMENTS

The system described herein is directed to an external cavity mode-locked solid state laser operating at selected emission wavelengths over the gain curve of the lasing material, such as Ti:Sapphire, Cr:LiSAF, rare earth doped glass fibers or other glass hosts doped with, for example, Ytterbium and/or Erbium, as well as semiconductor materials. The various selected emission wavelengths are commonly mode-locked with a controlled phase relationship between the modes.

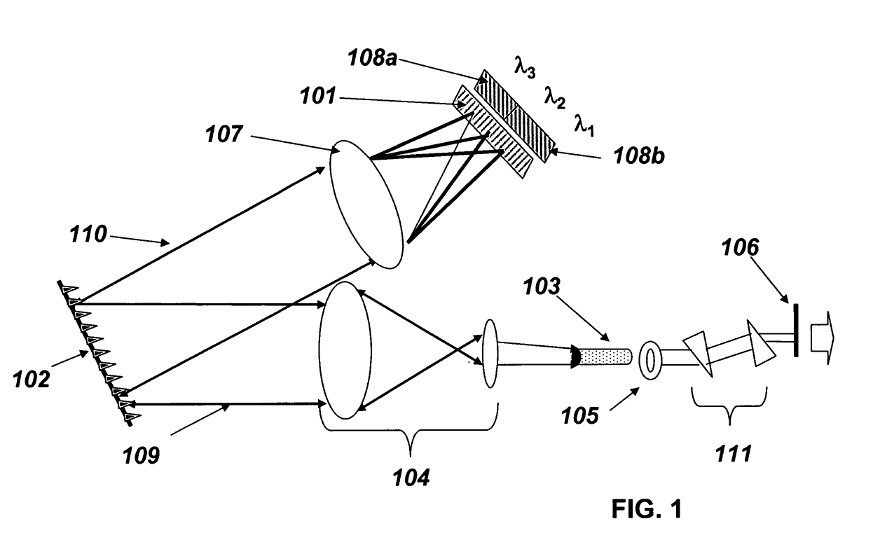

FIG. 1 shows schematically an exemplary mode-locked external cavity laser system 100 with a gain medium 103, for example, a Ti:Sapphire crystal, which may be optically pumped by a frequency doubled pulsed YAG laser emitting at 532 nm (not shown). In the depicted embodiment, the external cavity is formed by an end mirror 108 and a partially reflecting output mirror 106. The Ti:Sapphire exhibits Kerr lens mode-locking (KLM), which operates by focusing the high-intensity part of the beam by the Kerr effect, whereas the low-intensity parts remain unfocused. If such beam is passed through an aperture, such as the depicted aperture 105, the low-intensity parts are attenuated, thereby shortening the pulse. Accordingly, the “Kerr lens” produces a ‘non-resonant’ saturable absorber and hence is inherently broadband. Self-starting KLM operation has been demonstrated by using, for example, an intra-cavity semiconductor saturable absorber mirror (SESAM), which in the depicted configuration is represented by the end mirror 108. The SESAM 108 stabilizes the mode locking performance of the KLM.

The external cavity further includes a dispersive element (grating) 102 that diffracts the lasers beam 109 emitted by gain medium 103 after optional expansion by an optical lens or mirror system, for example, focusing telescope or relay lens 104, forming diffracted laser beams 110. Although the diffracted laser beams 110 are shown in FIG. 1 as a single beam, the different wavelengths in laser beam 109 are diffracted at slightly different angles. The differently angled diffracted laser beams are focused by collimating lens 107 onto the cavity end mirror 108. As also indicated in FIG. 1, cavity end mirror 108 may consist of several sections 108a, 108b that may have different reflectance bands. For example, mirror 108b may have a reflectivity peak at a shorter wavelength than mirror 108a.

SESAM's have been successfully used for mode-locking solid state lasers. However, the design of saturable absorbers can be optimized for either Q-switching or mode-locking.

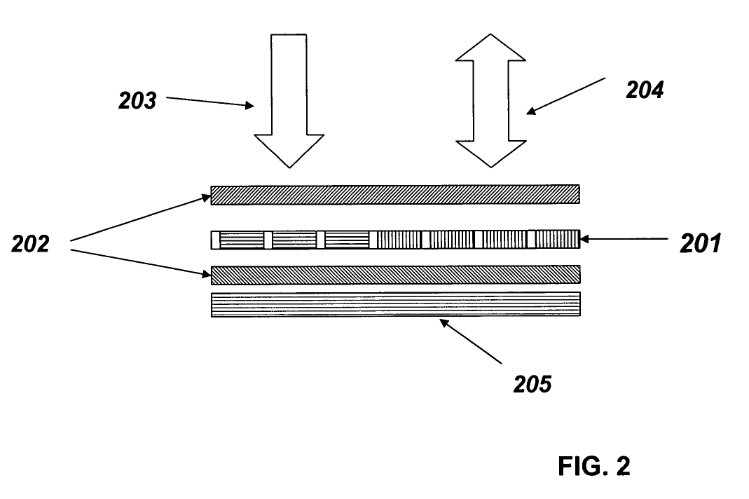

The external cavity of FIG. 1 further includes prism pair 111 for dispersion compensation. A collinear multi-wavelength laser beam exiting the face of gain medium 103 facing the aperture 105 will then remain collinear, albeit with a phase change, when impinging on output mirror 106, and exiting the output mirror as a collinear multi-wavelength mode-locked laser beam with a controlled spectral contents. The spectral contents can be controlled, for example, by placing inside the external cavity of FIG. 1 an array of phase-modulating or amplitude-modulating elements, for example, an addressable liquid crystal (LC) array 101, that can wavelength-selectively alter the amplitude or phase of the transmitted light at a wavelength corresponding to the position and addressing of the LC array element in the optical path. As shown in FIG. 2, the liquid crystal array having, for example, 512 elements, each having a lateral dimension of approximately 50 μm, is sandwiched between a pair of polarizers 202 and placed before cavity end mirror 108. Depending on the polarization direction of the light and the orientation of the polarizers 202 in relation to the orientation of the liquid crystal array elements, the incoming light can be either blocked 203 or not blocked and reflected 204 by the end mirror 108 (or SESAM 108). Rotated polarizations will be blocked by polarizers 202. The reflectivity of the array elements can be adjusted between 0 and 1 by suitably tuning the LC, for example, by applying an electric field. MEMS mirrors can be used instead of the LC/SESAM combination, in which case KLM provides the only mode-locking mechanism.

As mentioned above and shown in FIG. 1, two or more SESAM's 108a and 108b can be employed, with the SESAM's operating as cavity end mirrors. In this configuration, one SESAM will likely open first and act as the cavity master. The SESAM's that open second or third are termed the slaves. The use of more than one SESAM may also be required because SESAM's rarely exceed a bandwidth of 100 nm at center wavelengths of 700-1500 nm, whereas Ti:Sapphire has a bandwidth of 300 nm.

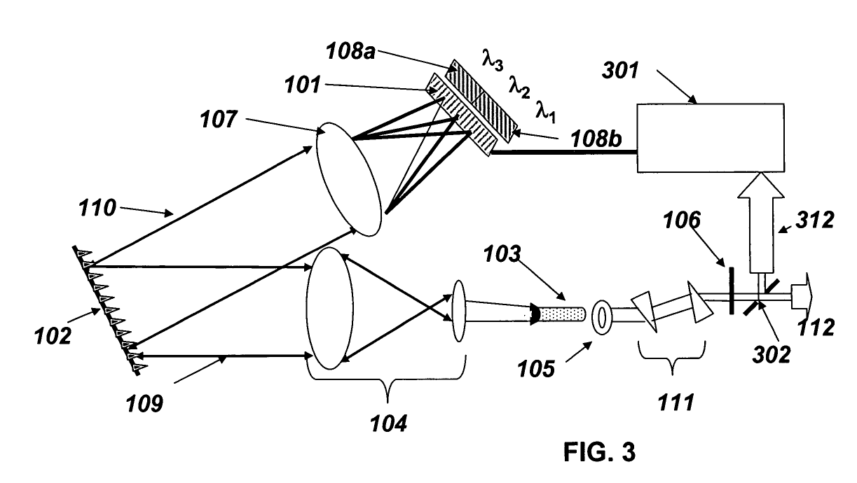

Turning now to FIG. 3, a beamsplitter 302 can be placed in collinear mode-locked output beam 112 that reflects a small portion 312 of beam 112 to a phase control and measurement system 301. The phase-measuring device intercepts the portion 312 and thereby determines a phase characteristic of the entire multi-wavelength mode-locked output beam 112, for example, with a frequency-resolved optical gating (FROG) device known in the art.

The signal measured by the phase-measuring device is analyzed and supplies a control variable, such as a control voltage, to the phase adjuster, for example, the liquid crystal array 101. As mentioned above, the phase adjuster can separately adjust the optical path length of the frequency elements in response to the determined phase characteristic so as to thereby adjust and lock the phases of all the modes.

The phase adjustment for intra-cavity dispersion may be both deterministic and adaptive. For example, the optical path can be adjusted by placing an intra-cavity prism, a liquid crystal and/or chirped dielectric mirror in the cavity. The intra-cavity liquid crystal optical array 101 may provide both the frequency selectivity and the selectable phase for each wavelength band. It should be noted that the phase selector may also select the polarization of each band to provide complete control over the characteristics of the optical pulse.

The disclosed mode-locked laser system can produce a collinear multi-wavelength mode-locked output beam 112 whose spectral content can be controlled by phase-adjusting element 101, for example, a LC array or an array of micro-mirrors (MEMS). Mode-locking is achieved through Kerr-lensing and aided by one or more SESAM end mirrors 108.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A mode-locked external cavity laser system, comprising:
a gain element collinearly propagating a multi-wavelength optical beam;
a diffracting element that diffracts the multi-wavelength optical beam exiting a first face of the gain element into a plurality of diffracted optical beams;
a wavelength-selective device receiving the plurality of diffracted optical beams and controllably transmitting the diffracted optical beams with a selected wavelength; and
at least one mode-locking device configured to commonly mode-lock the multi-wavelength optical beam.

2. The system of claim 1, wherein the gain element comprises a solid state laser material.

3. The system of claim 2, wherein the solid state laser material comprises at least one of a Ti:Sapphire crystal, a Cr:LiSAF crystal, and an Er-doped or Yb-doped glass.

4. The system of claim 1, wherein the mode-locking device comprises at least one semiconductor saturable absorber mirror (SESAM).

5. The system of claim 1, wherein the wavelength-selective device comprises an addressable liquid-crystal light valve.

6. The system of claim 4, wherein the addressable liquid-crystal light valve comprises spaced-apart separately controllable pixels capable of changing at a phase or an amplitude, or both, of the transmitted optical beams.

7. The system of claim 1, further comprising
a phase-measuring device intercepting a portion of the collinear optical beam exiting a second face of the gain medium and determining a phase characteristic of the exiting collinear multi-wavelength optical beam; and
a phase adjuster configured to separately adjust an optical path length of the plurality of diffracted optical beams in response to the determined phase characteristic.

8. The system of claim 1, further including dispersion compensation means.

9. The system of claim 6, wherein the phase-measuring device comprises a frequency-resolved optical gating (FROG) device.
